(19) United States
(12) Patent Application Publication
(10) Pub. No.: US 2021/0194705 A1
(43) Pub. Date: Jun. 24, 2021

(54) CERTIFICATE GENERATION METHOD

(71) Applicant: Panasonic lntellectual Property Management Co., Ltd., Osaka (JP)

(72) Inventor: Tomoki TAKAZOE, Kanagawa (JP)

(21) Appl. No.: 17/268,066

(22) PCT Filed: May 10, 2019
(86) PCT No.: PCT/JP2019/018804

§ 371 Date: Feb. 11, 2021

(30) Foreign Application Priority Data
Aug. 28, 2018 (JP) 2018-159396

(51) Int. Cl. H04L 9/32

(52) U.S. Cl. CPC H04L 9/3268; H04L 9/3247

(57) ABSTRACT

A certificate generation apparatus reads a chip manufacturer certificate stored in a device in advance. The certificate generation apparatus certifies that the chip manufacturer certificate is legitimate based on the signature signed by the chip manufacturer CA, when a public key encryption system indicated by the chip manufacturer certificate matches a public key encryption system of the certification organization CA. The certificate generation apparatus acquires the certification organization certificate including the client public key and the signature signed by the certification organization CA when the chip manufacturer certificate is certified to be legitimate. The certificate generation apparatus writes, in the device, the certification organization certificate.

### TECHNICAL FIELD

The present disclosure relates to data processing technology and, more particularly, to a certificate generation method, a certificate generation apparatus, and a computer program.

### BACKGROUND ART

Embedded devices connected to the Internet, i.e., so-called Internet of Things (IoT) devices, have become popular rapidly. In association with this, malware attacks have increased. The power of individual IoT devices may be small, but the number thereof is large so that the strength of attack displayed when they form a botnet will be great. Some IoT devices control access by using a user name and a password. However, access control based on a user name and a password has allowed illegal access by malware in some cases.

In one approach, this is addressed by storing an electronic certificate in an IoT device and using the electronic certificate to perform the mutual certification, key sharing, and encrypted communication between devices.
[Patent literature 1] JP2011-193490

### SUMMARY OF INVENTION

### Technical Problem

Recently, studies have been made on storage of a secret key and a public key certificate in a semiconductor chip when the semiconductor chip is manufactured. The method guarantees the legitimacy of a semiconductor chip, but it is difficult to realize mutual connection between various devices certified by a certification authority different from the certification authority on the side of the chip manufacturer.

The disclosure addresses the above-described issue, and a general purpose thereof is to efficiently realize connection with various devices certified by a particular certification authority, by utilizing key data stored in a device in advance.

### Solution to Problem

A certificate generation method is implemented by a computer and adapted to store, in a device that stores a first secret key and a first certificate, a second certificate, the first certificate including a first public key corresponding to the first secret key and a signature signed by a first certification authority, and the second certificate including a signature signed by a second certification authority different from the first certification authority, the method including: reading the first certificate from the device; certifying that the first certificate is legitimate based on the signature signed by the first certification authority, when a public key encryption system indicated by the first certificate read by the reading matches a public key encryption system of the second certification authority; acquiring the second certificate including the first public key and the signature signed by the second certification authority when the first certificate is certified to be legitimate by the certifying; and writing, in the device, the second certificate acquired by the acquiring.

Another embodiment of the present disclosure also relates to a certificate generation method. The method is implemented by a computer and adapted to store, in a device that stores a first secret key and a first certificate, a second certificate, the first certificate including a first public key corresponding to the first secret key and a signature signed by a first certification authority, and the second certificate including a signature signed by a second certification authority different from the first certification authority, the method including: reading the first certificate from the device; generating, when a public key encryption system indicated by the first certificate read by the reading does not match a public key encryption system of the second certification authority, a second public key corresponding to the first secret key, based on the public key encryption system of the second certification authority; acquiring the second certificate including the second public key generated by the generating and the signature signed by the second certification authority; and writing, in the device, the second certificate acquired by the acquiring.

Another embodiment of the present disclosure also relates to a certificate generation method. The method is implemented by a computer and adapted to store, in a device that stores a first secret key and a first certificate, a second certificate, the first certificate including a first public key corresponding to the first secret key and a signature signed by a first certification authority, and the second certificate including a signature signed by a second certification authority different from the first certification authority, the method including: generating a second secret key different from the first secret key, based on the first secret key stored in the device; generating a second public key corresponding to the second secret key generated by the generating of the second secret key; acquiring the second certificate including the second public key, generated by the generating of the second public key, and the signature signed by the second certification authority; and writing, in the device, the second certificate acquired by the acquiring.

Another embodiment of the present disclosure relates to a certificate generation apparatus. The apparatus is adapted to store, in a device that stores a first secret key and a first certificate, a second certificate, the first certificate including a first public key corresponding to the first secret key and a signature signed by a first certification authority, and the second certificate including a signature signed by a second certification authority different from the first certification authority, the certificate generation apparatus including: a reading unit that reads the first certificate from the device; a certification unit that certifies that the first certificate is legitimate based on the signature signed by the first certification authority, when a public key encryption system indicated by the first certificate read by the reading unit matches a public key encryption system of the second certification authority; an acquisition unit that acquires the second certificate including the first public key and the signature signed by the second certification authority when the first certificate is certified to be legitimate by the certification unit; and a writing unit that writes, in the device, the second certificate acquired by the acquisition unit.

Another embodiment of the present disclosure also relates to a certificate generation apparatus. The apparatus is adapted to store, in a device that stores a first secret key and a first certificate, a second certificate, the first certificate including a first public key corresponding to the first secret key and a signature signed by a first certification authority, and the second certificate including a signature signed by a second certification authority different from the first certification authority, the certificate generation apparatus including: a reading unit that reads the first certificate from the device; a generation unit that generates, when a public key encryption system indicated by the first certificate read by the reading unit does not match a public key encryption system of the second certification authority, a second public key corresponding to the first secret key, based on the public key encryption system of the second certification authority; an acquisition unit that acquires the second certificate including the second public key generated by the generation unit and the signature signed by the second certification authority; and a writing unit that writes, in the device, the second certificate acquired by the acquisition unit.

Another embodiment of the present disclosure also relates to a certificate generation apparatus. The apparatus is adapted to store, in a device that stores a first secret key and a first certificate, a second certificate, the first certificate including a first public key corresponding to the first secret key and a signature signed by a first certification authority, and the second certificate including a signature signed by a second certification authority different from the first certification authority, the certificate generation apparatus including: a secret key generation unit that generates a second secret key different from the first secret key, based on the first secret key stored in the device; a public key generation unit that generates a second public key corresponding to the second secret key generated by the secret key generation unit; an acquisition unit that acquires the second certificate including the second public key, generated by the public key generation unit, and the signature signed by the second certification authority; and a writing unit that writes, in the device, the second certificate acquired by the acquisition unit.

Optional combinations of the aforementioned constituting elements, and implementations of the present disclosure in the form of computer programs, recording mediums encoded with computer programs, etc. may also be practiced as additional modes of the present disclosure.

### Advantageous Effects of Invention

According to the present disclosure, connection with various devices certified by a particular certification authority is efficiently realized, by utilizing key data stored in a device in advance.

### BRIEF DESCRIPTION OF DRAWINGS

FIG. 1 shows a configuration of a certificate processing system according to the first embodiment;

FIG. 2 is a block diagram showing functional blocks of the certificate generation apparatus according to the first embodiment;

FIG. 3 is a flowchart showing the operation of the certificate generation apparatus according to the first embodiment;

FIG. 4 is a block diagram showing functional blocks of the certificate generation apparatus 14 according to the second embodiment; and

FIG. 5 is a flowchart showing the operation of the certificate generation apparatus according to the second embodiment.

### DESCRIPTION OF EMBODIMENTS

The apparatus or the entity that executes the method according to the disclosure is provided with a computer. By causing the computer to run a program, the function of the apparatus or the entity that executes the method according to the disclosure is realized. The computer is comprised of a processor that operates in accordance with the program as a main hardware feature. The disclosure is non-limiting as to the type of the processor so long as the function is realized by running the program. The processor is comprised of one or a plurality of electronic circuits including a semiconductor integrated circuit (IC) or a large-scale integration (LSI). The processor is comprised of one or a plurality of electronic circuits including a semiconductor integrated circuit (IC) or a large-scale integration (LSI). A field programmable gate array (FPGA) programmed after the LSI is manufactured, or a reconfigurable logic device, in which the connections inside the LSI are reconfigurable or the circuitry blocks inside the LSI can be set up, can be used for the same purpose. The plurality of electronic circuits may be integrated in one chip or provided in a plurality of chips. The plurality of chips may be aggregated in one device or provided in a plurality of apparatuses. The program is recorded in a non-transitory recording medium such as a computer-readable ROM, optical disk, and hard disk drive. The program may be stored in a recording medium in advance or supplied to a recording medium via wide area communication network including the Internet.

A summary of the embodiment is given below. Recently, studies have been made on storage of a secret key and a public key certificate in a semiconductor chip when the semiconductor chip is manufactured. The public key certificate includes a digital signature (hereinafter, simply referred to as “signature”) of a certification authority (hereinafter, also referred to as “CA”) on the side of a chip manufacturer. Therefore, the legitimacy of a semiconductor chip is guaranteed, but it is difficult to realize mutual connection between various devices certified by a particular certification authority or a particular organization different from the CA on the side of the chip manufacturer. Further, a public key certificate including a signature of the particular certification authority or the particular organization will be necessary for such mutual connection.

Meanwhile, a chip manufacturer stores a secret key and a public key certificate in an area in a semiconductor chip that is highly tamper resistant. In this background, we have thought that the efforts, resources, and number of management steps required to install a new secret key to obtain certification by a particular certification authority are reduced by using the secret key and the public key certificate stored in the semiconductor chip in advance. In the embodiments, a description will be given of a technology of utilizing key data stored in a device in advance to store a public key certificate issued by a particular certification authority in the device.

### First Embodiment

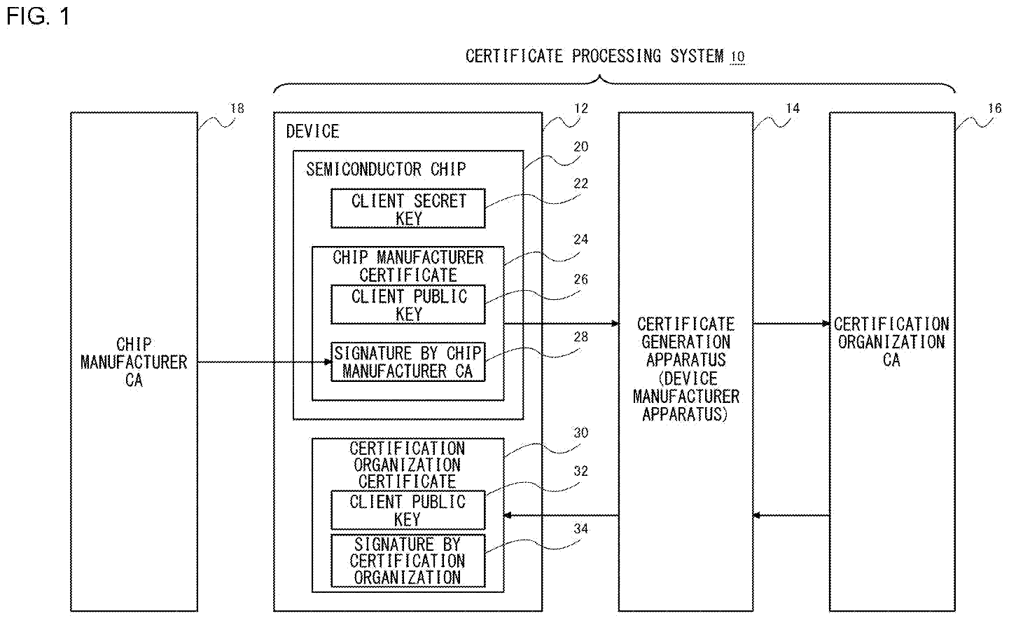

FIG. 1 shows a configuration of a certificate processing system 10 according to the first embodiment. The certificate processing system 10 includes a device 12, a certificate generation apparatus 14, and a certification organization CA 16. The certification organization CA 16 is an information processing apparatus (server, etc.) of a certification authority that delivers, in order to support mutual connection between a plurality of types of devices of a plurality of corporations, a public key certificate to the devices. The certificate generation apparatus 14 is an information processing apparatus (server, etc.) of one of the plurality of corporations (hereinafter, referred to as “device manufacturers”) that use the certification organization CA 16. The detail of the function of the certificate generation apparatus 14 will be described later.

The device 12 is a device manufactured by the device manufacturer. The device 12 may be an IoT device or a device connectable to a Home Energy Management System (HEMS). For example, the device 12 may be a home electric appliance (e.g., an air conditioner, a refrigerator), an electronic device (e.g., a PC, a smartphone), an electric facility (e.g., a smart meter, a storage battery), or a sensor (e.g., a temperature sensor, an illuminance sensor).

The device 12 includes a semiconductor chip 20 manufactured by a chip manufacturer. The semiconductor chip 20 may be an IC chip or a System on a Chip (SoC). A client secret key 22, which is a secret key set by the chip manufacturer, and a chip manufacturer certificate 24, which is a public key certificate, are stored in a predetermined tamper resistant area in the semiconductor chip 20.

The chip manufacturer certificate 24 includes a client public key 26 set by the chip manufacturer and a signature 28 signed by using the secret key of a chip manufacturer CA 18, which is an apparatus of a certification authority on the side of the chip manufacturer. The client public key 26 is key data corresponding to (i.e., pairing with) the client secret key 22. The chip manufacturer certificate 24 also includes data (not shown) indicating the type of public key encryption system (stated otherwise, an algorithm (e.g., Rivest Shamir Adleman (RSA), etc.)).

Further, the certificate generation apparatus 14 stores a certification organization certificate 30, which is a public key certificate provided by the certification organization CA 16, in the device 12. The certification organization certificate 30 includes a client public key 32 corresponding to the client secret key 22 and a signature 34 signed by using the secret key of the certification organization CA 16.

As will be described later, when the encryption system of the client public key 26 stored in the semiconductor chip 20 matches the encryption system of the certification organization CA 16, the same data as set for the client public key 26 is set for the client public key 32 of the certification organization certificate 30. When the encryption system of the client public key 26 stored in the semiconductor chip 20 does not match the encryption system of the certification organization CA 16, on the other hand, a newly generated public key different from the client public key 26 is set as the client public key 32 of the certification organization certificate 30.

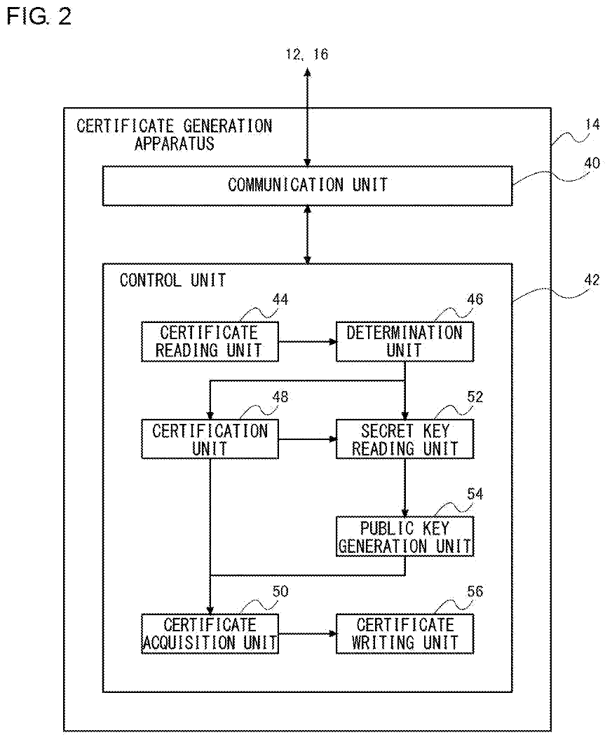

FIG. 2 is a block diagram showing functional blocks of the certificate generation apparatus 14 according to the first embodiment. The blocks depicted in the block diagram of this disclosure are implemented in hardware such as devices and mechanical apparatus exemplified by a CPU and a memory of a computer, and in software such as a computer program. FIG. 2 depicts functional blocks implemented by the cooperation of these elements. Therefore, it will be understood by those skilled in the art that the functional blocks may be implemented in a variety of manners by a combination of hardware and software.

The certificate generation apparatus 14 includes a communication unit 40 and a control unit 42. The communication unit 40 communicates with an external apparatus via a communication network (LAN, WAN, Internet, etc.) (not shown) in accordance with a predetermined communication protocol. The control unit 42 performs various data processes for setting a public key certificate (the certification organization certificate 30) of the certification organization CA 16 in the device 12. The control unit 42 transmits and receives data to and from the device 12 and the certification organization CA 16 via the communication unit 40. The certificate generation apparatus 14 may further include a storage unit for temporarily or permanently storing data referred to or updated by the control unit 42.

The control unit 42 includes a certificate reading unit 44, a determination unit 46, a certification unit 48, a certificate acquisition unit 50, a secret key reading unit 52, a public key generation unit 54, and a certificate writing unit 56. A computer program in which a plurality of these functional blocks are implemented may be stored in a recording medium and installed in a storage of the certificate generation apparatus 14 via the recording medium. Alternatively, the computer program may be installed in the storage of the certificate generation apparatus 14 via a communication network. The CPU of the certificate generation apparatus 14 may exhibit the functions of the respective functional blocks by reading the computer program into the main memory and executing the computer program.

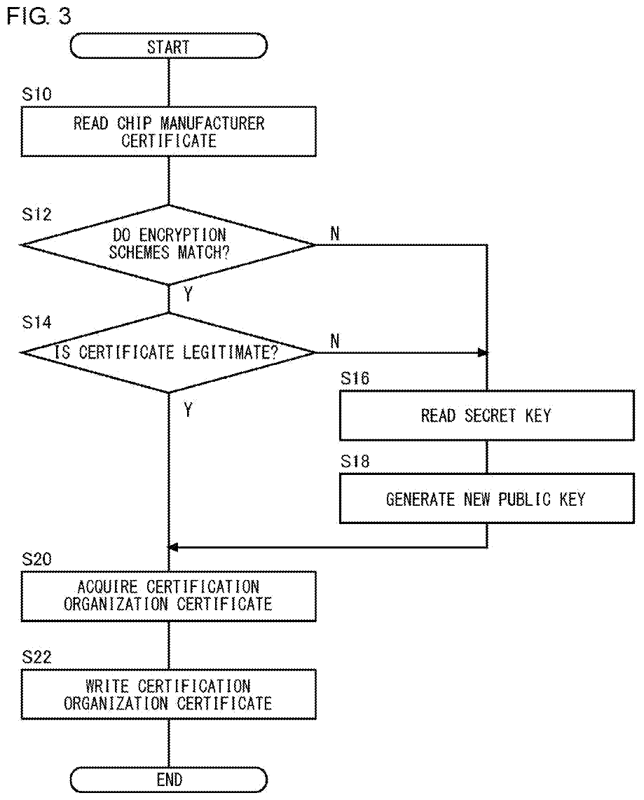

A description will now be given of the operation of the certificate generation apparatus 14 having the above-described configuration. FIG. 3 is a flowchart showing the operation of the certificate generation apparatus 14 according to the first embodiment. The process shown in the figure is performed immediately after the semiconductor chip 20 is installed in the device 12 in the process of manufacturing the device 12. The certificate reading unit 44 reads the chip manufacturer certificate 24 stored in the semiconductor chip 20 of the device 12 via the communication network (S10).

The determination unit 46 determines whether the public key encryption system indicated by the chip manufacturer certificate 24 read by the certificate reading unit 44 matches a predetermined public key encryption system of the certification organization CA 16. The public key encryption system may include a key generation algorithm, an encryption algorithm, and a decoding algorithm. When a mismatch is found in at least one of these three algorithms, the determination unit 46 may determine that the public key encryption systems do not match.

If it is determined by the determination unit 46 that the public key encryption systems match (Y in S12), the certification unit 48 certifies the legitimacy of the chip manufacturer certificate 24 based on the signature 28 included in the chip manufacturer certificate 24 and the public key of the chip manufacturer CA 18 stored in advance. Stated otherwise, the certification unit 48 certifies the signature 28 by the chip manufacturer CA 18 to confirm that the chip manufacturer certificate 24 is legitimate (e.g., not falsified).

When the certification unit 48 confirms the legitimacy of the chip manufacturer certificate 24 (Y in S14), the certificate acquisition unit 50 transmits a certificate signing request (CSR) including the client public key 26 included in the chip manufacturer certificate 24 to the certification organization CA 16 via the communication network. In response to the certificate signing request, the certification organization CA 16 transmits the certification organization certificate 30 including the client public key 32 (identical to the client public key 26 transmitted by the certificate acquisition unit 50) and the signature signed by using the secret key of the certification organization CA 16 to the certificate generation apparatus 14. The certificate acquisition unit 50 acquires the certification organization certificate 30 transmitted from the certification organization CA 16 via the communication network (S20).

When it is determined that the public key encryption system indicated by the chip manufacturer certificate 24 does not match the public key encryption system of the certification organization CA 16 (N in S12), on the other hand, the secret key reading unit 52 reads the client secret key 22 stored in the semiconductor chip 20 of the device 12 via the communication network (S16). Similarly, when the chip manufacturer certificate 24 is not found to be legitimate, i.e., when certification of the signature 28 by the chip manufacturer CA 18 fails (N in S14), the secret key reading unit 52 reads the client secret key 22 (S16).

The public key generation unit 54 generates a new public key (the client public key 32) corresponding to the client secret key 22 in accordance with the client secret key 22 read by the secret key reading unit 52 and the public key encryption system of the certification organization CA 16 (S18). For example, the public key generation unit 54 generates a new public key pairing with the client secret key 22 in accordance with the key generation algorithm in the certification organization CA 16.

The certificate acquisition unit 50 transmits a certificate signing request including the client public key 32 generated by the public key generation unit 54 to the certification organization CA 16. The certification organization CA 16 transmits, to the certificate generation apparatus 14, the certification organization certificate 30 including the client public key 32 (identical to the one transmitted by the certificate acquisition unit 50) and the signature 34 signed by using the secret key of the certification organization CA 16. The certificate acquisition unit 50 acquires the certification organization certificate 30 transmitted from the certification organization CA 16 (S20).

The certificate writing unit 56 writes the certification organization certificate 30 acquired by the certificate acquisition unit 50 in the device 12 via the communication network (S22). The certificate writing unit 56 may transmit the certification organization certificate 30 to the device 12 and cause the device 12 to perform a process of saving the certification organization certificate 30 in a predetermined storage unit.

An application for communicating with another device (e.g., another IoT device or another device within the HEMS) certified by the certification organization CA 16 may be installed in the device 12. When communicating with another device certified by the certification organization CA 16, the application may use the client secret key 22 and the certification organization certificate 30 to perform mutual certification, key sharing, and encrypted communication, electronic signing, etc.

According to the first embodiment, the process of storing, in the device 12, the public key certificate issued by the certification organization CA 16 different from the chip manufacturer CA 18 is made more efficient than in the related art, by utilizing the key data stored in the semiconductor chip 20 of the device 12 in advance. In this way, connection between various devices certified by the certification organization CA 16 and the device 12 is realized efficiently.

### Second Embodiment

In the second embodiment, a technology is proposed wherein the first embodiment is used as the basic configuration, and, at the same time, the risk of the client secret key 22 of the device 12 being leaked is reduced more successfully. In the following description, the difference from the first embodiment is mainly highlighted, and the details already described in the first embodiment are omitted as appropriate. Further, constituting elements identical or equivalent to those of the first embodiment shall be denoted by the same reference numerals.

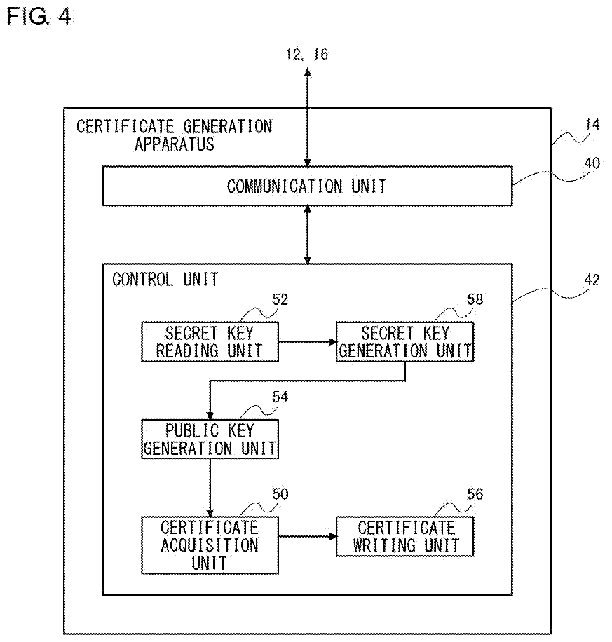

The configuration of the certificate processing system 10 according to the second embodiment is similar to that of the first embodiment (FIG. 1). FIG. 4 is a block diagram showing functional blocks of the certificate generation apparatus 14 according to the second embodiment. The control unit 42 of the certificate generation apparatus 14 includes the secret key reading unit 52, a secret key generation unit 58, the public key generation unit 54, the certificate acquisition unit 50, and the certificate writing unit 56.

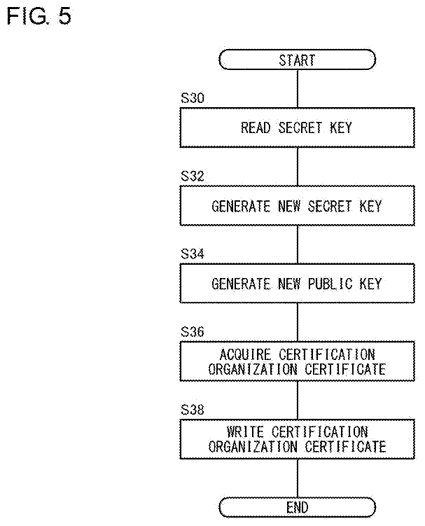

FIG. 5 is a flowchart showing the operation of the certificate generation apparatus 14 according to the second embodiment. The secret key reading unit 52 reads the client secret key 22 stored in the semiconductor chip 20 of the device 12 (S30). The secret key generation unit 58 generates, based on the client secret key 22 read by the secret key reading unit 52, a new secret key (hereinafter, also referred to as “a special secret key”) for mutual certification or secure communication with the devices certificated by the certification organization CA 16 (S32), the new secret key being different from the client secret key 22. For example, the secret key generation unit 58 may use a key derivation function based on “PRF_HMAC_SHA2_256” defined by Internet engineering Task Force (IETF) to generate the special secret key from the client secret key 22.

The public key generation unit 54 generates a new public key (the client public key 32) corresponding to the special secret key in accordance with the special secret key generated by the secret key generation unit 58 and the public key encryption system of the certification organization CA 16 (S34). The certificate acquisition unit 50 transmits a certificate signing request including the client public key 32 generated by the public key generation unit 54 to the certification organization CA 16 to acquire the certification organization certificate 30 including the client public key 32 and the signature 34 of the certification organization CA 16 (S36). The certificate writing unit 56 writes the certification organization certificate 30 acquired by the certificate acquisition unit 50 in the device 12 (S38).

An application for communicating with another device (e.g., another IoT device or another device within the HEMS) certified by the certification organization CA 16 may be installed in the device 12. When communicating with a device certified by the certification organization CA 16, the application may dynamically calculate the special secret key according to the same algorithm as used in the secret key generation unit 58 of the certificate generation apparatus 14 and use the special secret key and the certification organization certificate 30 to perform mutual certification, key sharing, and encrypted communication, electronic signing, etc.

The secret key generation unit 58 may write the special secret key thus generated in a predetermined storage area (preferably, a tamper resistant area) of the device 12. When communicating with a device certified by the certification organization CA 16, the above-mentioned application of the device 12 may use the special secret key stored in the above storage area. According to configuration of the second embodiment, the risk of the client secret key 22 being leaked is reduced.

Given above is a description of the disclosure based on the first and second embodiments. The embodiments are intended to be illustrative only and it will be understood by those skilled in the art that various modifications to constituting elements and processes could be developed and that such modifications are also within the scope of the present disclosure.

A description will be given of a variation of the second embodiment. The function of the secret key generation unit 58 provided in the certificate generation apparatus 14 according to the second embodiment may be provided in the device 12. It will be assumed here that the device 12 is provided with the secret key generation unit. In this variation, the secret key reading unit 52 of the certificate generation apparatus 14 requests the device 12 to provide the secret key. In response to the request, the secret key generation unit of the device 12 generates a new secret key (the special secret key of the second embodiment) based on the client secret key 22 and transmits the special secret key to the certificate generation apparatus 14. The public key generation unit 54 of the certificate generation apparatus 14 generates a new public key (the client public key 32) corresponding to the special secret key, based on the special secret key transmitted from the device 12. The subsequent steps are similar to those of the second embodiment. According to this variation, the information on the client secret key 22 is not accessed from outside the device 12 so that the risk of the client secret key 22 being leaked is reduced more successfully.

Any combination of the embodiment and a variation will also be useful as an embodiment of the present disclosure. A new embodiment created by a combination will provide the combined advantages of the embodiment and the variation as combined. It will be understood to a skilled person that the functions that the constituting elements recited in the claims should achieve are implemented either alone or in combination by the constituting elements shown in the embodiments and the variations.

The technologies according to the embodiments and variations may be defined by the following items.

### [Item 1]

A certificate generation method implemented by a computer (14) and adapted to store, in a device (12) that stores a first secret key (22) and a first certificate (24), a second certificate (30), the first certificate including a first public key (26) corresponding to the first secret key (22) and a signature (28) signed by a first certification authority (18), and the second certificate (30) including a signature (34) signed by a second certification authority (16) different from the first certification authority (18), the method comprising: reading the first certificate (24) from the device (12); certifying that the first certificate (24) is legitimate based on the signature (28) signed by the first certification authority (18), when a public key encryption system indicated by the first certificate (24) read by the reading matches a public key encryption system of the second certification authority (16); acquiring the second certificate (30) including the first public key (26, 32) and the signature (34) signed by the second certification authority (16) when the first certificate (24) is certified to be legitimate by the certifying; and writing, in the device (12), the second certificate (30) acquired by the acquiring.

According to this certificate generation method, the process of storing a certificate issued by the second certification authority in the device is realized efficiently by using the secret key and the public key stored in the device in advance. For example, the efforts, resources, and number of management steps required to generate a new secret key and public key and to install the keys in the device are reduced.

[Item 2] The certificate generation method according to item 1, wherein the reading reads the first certificate (24) from the device (12) via a communication network, the acquiring acquires the second certificate (30) from an apparatus of the second certification authority (16) via a communication network, the writing writes the second certificate (30) in the device (12) via a communication network, and the reading, the certifying, the acquiring, and the writing are performed by using a processor of the computer (14) to run a predetermined computer program.

Thus, the certificate generation method can be executed by coordinating the communication network and the computer hardware and software.

### [Item 3]

A certificate generation method implemented by a computer (14) and adapted to store, in a device (12) that stores a first secret key (22) and a first certificate (24), a second certificate (30), the first certificate including a first public key (26) corresponding to the first secret key (22) and a signature (28) signed by a first certification authority (18), and the second certificate including a signature (34) signed by a second certification authority (16) different from the first certification authority (18), the method comprising: reading the first certificate (24) from the device (12); generating, when a public key encryption system indicated by the first certificate (24) read by the reading does not match a public key encryption system of the second certification authority (16), a second public key (32) corresponding to the first secret key (22), based on the public key encryption system of the second certification authority (16); acquiring the second certificate (30) including the second public key (32) generated by the generating and the signature (34) signed by the second certification authority (16); and writing, in the device (12), the second certificate (30) acquired by the acquiring.

According to this certificate generation method, the process of storing a certificate issued by the second certification authority is realized efficiently by using the secret key stored in the device in advance.

For example, the efforts, resources, and number of management steps required to generate a new secret key and to install the key in the device are reduced.

### [Item 4]

A certificate generation method implemented by a computer (14) and adapted to store, in a device (12) that stores a first secret key (22) and a first certificate (24), a second certificate (30), the first certificate (24) including a first public key (26) corresponding to the first secret key (22) and a signature (28) signed by a first certification authority (18), and the second certificate (30) including a signature (34) signed by a second certification authority (16) different from the first certification authority (18), the method comprising: generating a second secret key different from the first secret key (22), based on the first secret key (22) stored in the device (12); generating a second public key (32) corresponding to the second secret key generated by the generating of the second secret key; acquiring the second certificate (30) including the second public key (32), generated by the generating of the second public key (32), and the signature (34) signed by the second certification authority (16); and writing, in the device (12), the second certificate (30) acquired by the acquiring.

According to this certificate generation method, the process of storing a certificate issued by the second certification authority is realized efficiently by using the secret key stored in the device in advance. Further, the risk of the secret key stored in the device in advance being leaked is reduced more successfully.

### [Item 5]

A certificate generation apparatus (14) adapted to store, in a device (12) that stores a first secret key (22) and a first certificate (24), a second certificate (30), the first certificate (24) including a first public key (26) corresponding to the first secret key (22) and a signature (28) signed by a first certification authority (18), and the second certificate (30) including a signature (34) signed by a second certification authority (16) different from the first certification authority (18), the certificate generation apparatus (14) comprising: a reading unit (44) that reads the first certificate (24) from the device (12); a certification unit (48) that certifies that the first certificate (24) is legitimate based on the signature (28) signed by the first certification authority (18), when a public key encryption system indicated by the first certificate (24) read by the reading unit (44) matches a public key encryption system of the second certification authority (16); an acquisition unit (50) that acquires the second certificate (30) including the first public key (16, 32) and the signature (34) signed by the second certification authority (16) when the first certificate (24) is certified to be legitimate by the certification unit (48); and a writing unit (56) that writes, in the device (12), the second certificate (30) acquired by the acquisition unit (50).

According to this certificate generation apparatus, the process of storing a certificate issued by the second certification authority in the device is realized efficiently by using the secret key and the public key stored in the device in advance.

For example, the efforts, resources, and number of management steps required to generate a new secret key and public key and to install the keys in the device are reduced.

### [Item 6]

A certificate generation apparatus (14) adapted to store, in a device (12) that stores a first secret key (22) and a first certificate (24), a second certificate (30), the first certificate (24) including a first public key (26) corresponding to the first secret key (22) and a signature (28) signed by a first certification authority (18), and the second certificate (30) including a signature signed (34) by a second certification authority (16) different from the first certification authority (18), the certificate generation apparatus (14) comprising: a reading unit (44) that reads the first certificate (24) from the device (12); a generation unit (54) that generates, when a public key encryption system indicated by the first certificate (24) read by the reading unit does not match a public key encryption system of the second certification authority (16), a second public key (32) corresponding to the first secret key (22), based on the public key encryption system of the second certification authority (16); an acquisition unit (50) that acquires the second certificate (30) including the second public key (32) generated by the generation unit (54) and the signature signed by the second certification authority (16); and a writing unit (56) that writes, in the device (12), the second certificate (30) acquired by the acquisition unit (50).

According to this certificate generation apparatus, the process of storing a certificate issued by the second certification authority is realized efficiently by using the secret key stored in the device in advance.

For example, the efforts, resources, and number of management steps required to generate a new secret key and to install the key in the device are reduced.

### [Item 7]

A certificate generation apparatus (14) adapted to store, in a device that stores a first secret key (22) and a first certificate (24), a second certificate (30), the first certificate (24) including a first public key (26) corresponding to the first secret key (22) and a signature signed (28) by a first certification authority (18), and the second certificate (30) including a signature (34) signed by a second certification authority (16) different from the first certification authority (18), the certificate generation apparatus (14) comprising: a secret key generation unit (58) that generates a second secret key different from the first secret key (22), based on the first secret key (22) stored in the device (12); a public key generation unit (54) that generates a second public key (32) corresponding to the second secret key generated by the secret key generation unit (58); an acquisition unit (50) that acquires the second certificate (30) including the second public key (32), generated by the public key generation unit (54), and the signature (34) signed by the second certification authority (16); and a writing unit (56) that writes, in the device (12), the second certificate (30) acquired by the acquisition unit (50).

According to this certificate generation apparatus, the process of storing a certificate issued by the second certification authority in the device is realized efficiently by using the secret key stored in the device in advance.

Further, the risk of the secret key stored in the device in advance being leaked is reduced more successfully.

### [Item 8]

A computer program adapted to store, in a device (12) that stores a first secret key (22) and a first certificate (24), a second certificate (30), the first certificate (24) including a first public key (26) corresponding to the first secret key (22) and a signature (28) signed by a first certification authority (18), and the second certificate (30) including a signature (34) signed by a second certification authority (16) different from the first certification authority (18), the computer program comprising modules implemented by a computer (14), including: a module that reads the first certificate (24) from the device (12); a module that certifies that the first certificate (24) is legitimate based on the signature (28) signed by the first certification authority (18), when a public key encryption system indicated by the first certificate (24) read matches a public key encryption system of the second certification authority (16); a module that acquires the second certificate (30) including the first public key (26) and the signature (34) signed by the second certification authority (16) when the first certificate (24) is certified to be legitimate; and a module that writes, in the device (12), the second certificate (30) acquired.

According to this computer program, the process of storing a certificate issued by the second certification authority in the device is realized efficiently by using the secret key and the public key stored in the device in advance.

For example, the efforts, resources, and number of management steps required to generate a new secret key and public key and to install the keys in the device are reduced.

### [Item 9]

A computer program adapted to store, in a device (12) that stores a first secret key (22) and a first certificate (24), a second certificate (30), the first certificate (24) including a first public key (26) corresponding to the first secret key (22) and a signature (28) signed by a first certification authority (18), and the second certificate (30) including a signature (34) signed by a second certification authority (16) different from the first certification authority (18), the computer program comprising modules implemented by a computer (14), including: a module that reads the first certificate (24) from the device (12); a module that generates, when a public key encryption system indicated by the first certificate (24) read does not match a public key encryption system of the second certification authority (16), a second public key (32) corresponding to the first secret key (22), based on the public key encryption system of the second certification authority (16); a module that acquires the second certificate (30) including the second public key (32) generated and the signature (34) signed by the second certification authority (16); and a module that writes, in the device (12), the second certificate (30) acquired.

According to this computer program, the process of storing a certificate issued by the second certification authority is realized efficiently by using the secret key stored in the device in advance.

For example, the efforts, resources, and number of management steps required to generate a new secret key and to install the key in the device are reduced.

### [Item 10]

A computer program adapted to store, in a device (12) that stores a first secret key (22) and a first certificate (24), a second certificate (30), the first certificate (24) including a first public key (26) corresponding to the first secret key (22) and a signature (28) signed by a first certification authority (18), and the second certificate (30) including a signature (34) signed by a second certification authority (16) different from the first certification authority (18), the computer program comprising modules implemented by a computer (14), including: a module that generates a second secret key different from the first secret key (22), based on the first secret key (22) stored in the device (12); a module that generates a second public key (32) corresponding to the second secret key generated; a module that acquires the second certificate (30) including the second public key (32) generated and the signature (34) signed by the second certification authority (16); and a module that writes, in the device (12), the second certificate (30) acquired.

According to this computer program, the process of storing a certificate issued by the second certification authority in the device is realized efficiently by using the secret key stored in the device in advance.

Further, the risk of the secret key stored in the device in advance being leaked is reduced more successfully.

### INDUSTRIAL APPLICABILITY

The technology described in this disclosure can be applied to computers that generate a certificate.

### REFERENCE SIGNS LIST

12 device, 14 certificate generation apparatus, 44 certificate reading unit, 46 determination unit, 48 certification unit, 50 certificate acquisition unit, 52 secret key reading unit, 54 public key generation unit, 56 certificate writing unit, 58 secret key generation unit

1. A certificate generation method implemented by a computer and adapted to store, in a device that stores a first secret key and a first certificate, a second certificate, the first certificate including a first public key corresponding to the first secret key and a signature signed by a first certification authority, and the second certificate including a signature signed by a second certification authority different from the first certification authority, the method comprising:
reading the first certificate from the device;
certifying that the first certificate is legitimate based on the signature signed by the first certification authority, when a public key encryption system indicated by the first certificate read by the reading matches a public key encryption system of the second certification authority;
acquiring the second certificate including the first public key and the signature signed by the second certification authority when the first certificate is certified to be legitimate by the certifying; and
writing, in the device, the second certificate acquired by the acquiring.

2. The certificate generation method according to claim 1, wherein
the reading reads the first certificate from the device via a communication network,
the acquiring acquires the second certificate from an apparatus of the second certification authority via a communication network,
the writing writes the second certificate in the device via a communication network, and
the reading, the certifying, the acquiring, and the writing are performed by using a processor of the computer to run a predetermined computer program.

3. A certificate generation method implemented by a computer and adapted to store, in a device that stores a first secret key and a first certificate, a second certificate, the first certificate including a first public key corresponding to the first secret key and a signature signed by a first certification authority, and the second certificate including a signature signed by a second certification authority different from the first certification authority, the method comprising:
reading the first certificate from the device;
generating, when a public key encryption system indicated by the first certificate read by the reading does not match a public key encryption system of the second certification authority, a second public key corresponding to the first secret key, based on the public key encryption system of the second certification authority;
acquiring the second certificate including the second public key generated by the generating and the signature signed by the second certification authority; and
writing, in the device, the second certificate acquired by the acquiring.

4. A certificate generation method implemented by a computer and adapted to store, in a device that stores a first secret key and a first certificate, a second certificate, the first certificate including a first public key corresponding to the first secret key and a signature signed by a first certification authority, and the second certificate including a signature signed by a second certification authority different from the first certification authority, the method comprising:
generating a second secret key different from the first secret key, based on the first secret key stored in the device;
generating a second public key corresponding to the second secret key generated by the generating of the second secret key;
acquiring the second certificate including the second public key, generated by the generating of the second public key, and the signature signed by the second certification authority; and
writing, in the device, the second certificate acquired by the acquiring.

5-10. (canceled)
